(19) United States
(12) Patent Application Publication
(10) Pub. No.: US 2025/0371606 A1
(43) Pub. Date: Dec. 4, 2025

(54) AUTOMATED GIFTING USING MACHINE LEARNING

(71) Applicant: American Express Travel Related Services Company, Inc., New York, NY (US)

(72) Inventors: Shilla KimParker, South Salem, NY (US); Joshua Block, Paramus, NJ (US); Swagat Tripathy, Jersey City, NJ (US)

(21) Appl. No.: 18/731,717

(22) Filed: Jun. 3, 2024

(51) Int. Cl. G06Q 30/0601; G06Q 10/083

(52) U.S. Cl. CPC G06Q 30/0631; G06Q 10/083

(57) ABSTRACT

Disclosed are various embodiments for automating the gift-giving process using machine learning. To begin, a computing device can identify a date and a recipient associated with the date. The computing device can obtain recipient data associated with the recipient, and using the recipient data as a key, query a graph database for a gift recommendation corresponding to the recipient. Additionally, using a generative machine learning model, the computing device can generate a gift message corresponding to the gift recommendation. Finally, the computing device can send the gift message to the recipient.

### BACKGROUND

When a person (e.g., a giver) wishes to purchase a gift for someone (e.g., a recipient), the giver may not know a variety of information about the recipient which would be helpful for selecting the perfect gift. Often, a giver may only have limited knowledge of the recipient to rely upon when selecting a gift. Investigating and anticipating the recipient's gift preferences, needs, or desires can be a challenging and time-consuming process with limited success.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example user interface rendered by a client device according to various embodiments of the present disclosure.

FIG. 2 is a drawing of a network environment according to various embodiments of the present disclosure.

FIG. 3 is a flowchart illustrating one example of functionality implemented as portions of an application executed in a computing environment in the network environment of FIG. 2 according to various embodiments of the present disclosure.

FIG. 4 is a flowchart illustrating one example of functionality implemented as portions of an application executed in a computing environment in the network environment of FIG. 2 according to various embodiments of the present disclosure.

FIG. 5 is a sequence diagram illustrating one example of the interactions between the components of the network environment of FIG. 2 according to various embodiments of the present disclosure.

### DETAILED DESCRIPTION

Disclosed are various approaches for automating the gift-giving process using machine learning. When a person (e.g., a giver) wishes to purchase a gift for someone (e.g., a recipient), the giver may not know or have access to a variety of information about the recipient which would be helpful for selecting the perfect gift. Often, a giver may only have limited knowledge of the recipient to rely upon when selecting a gift. For example, a giver is unlikely to know and understand the recipient's recent spending habits. More specifically, a giver may not know what the recipient has purchased for himself or herself in recent months. In another example, it would be extremely difficult and time-consuming for a giver to conduct demographic research to determine the gift preferences of other recipients similar to the giver's intended recipient. Investigating and anticipating the recipient's gift preferences, needs, or desires can be a challenging and time-consuming process with limited success.

Using machine learning to analyze these large sets of data on the giver, the recipient, and the population allows for greatly enhanced pattern-recognition and predictions which a human would otherwise miss or ignore. Coupling with generative artificial intelligence, the present disclosure allows for the targeted generation of enhanced gift recommendations based on the patterns and predictions produced from the use of machine learning. These gift recommendations are personalized to both giver and recipient as well as appropriate to the occasion. In addition, generative artificial intelligence can allow for the automatic selection of the best gift idea from a number of options based on the insights provided with machine learning. Finally, generative artificial intelligence can use the gift recommendations it produced to generate a personalized message to accompany the gift. Accordingly, various embodiments of the present disclosure provide for an automated gift recommendation service which uses a variety of internal data about the recipient as well as population data from similar recipients in order to identify and select a personalized gift for the recipient. Additionally, the gift recommendation service automates a variety of additional factors surrounding the gift-giving process, including, for example, the generation and delivery of a personalized message to accompany the gift. By using machine learning and population data from similar recipients which would otherwise be inaccessible to a giver, the gift recommendation service can develop a more robust gift recommendation in a shorter amount of time, thereby saving the giver time and resources.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

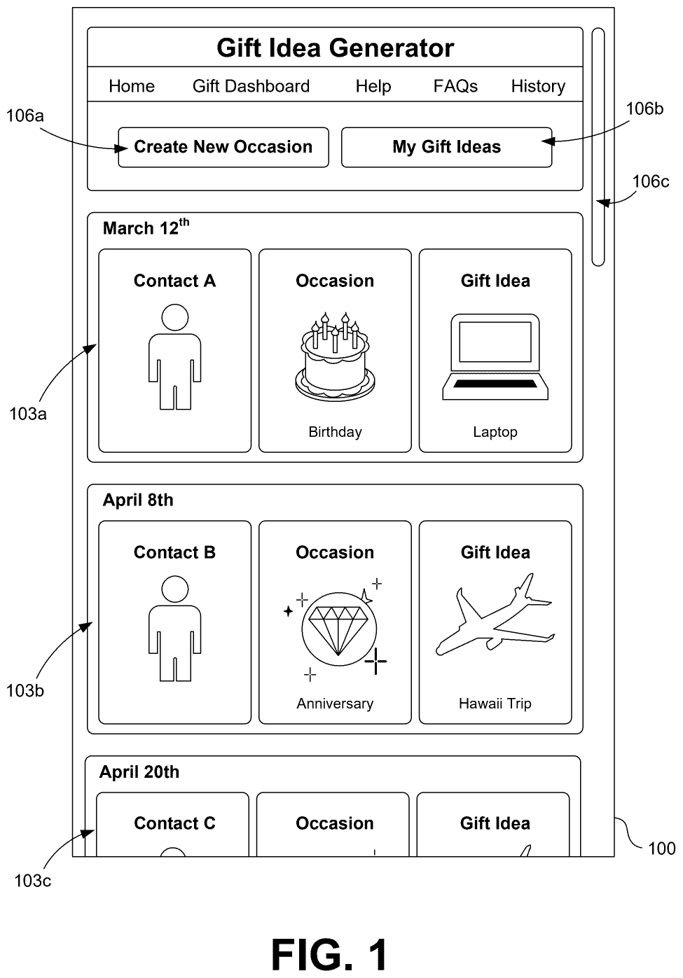

FIG. 1 depicts an example of a user interface 100 for presenting a user with a variety of gift ideas. The user interface 100 can show various information associated with one or more gift ideas 103 (e.g., 103a, 103b, 103c, etc.), such as the date of an occasion, the contact with whom the occasion is associated, the type of occasion, and the corresponding gift recommendation. In some examples, the user interface 100 can present multiple different gift ideas 103 to a user.

In addition to presenting current gift ideas 103, the user interface 100 can include one or more user interface elements 106 (e.g., 106a, 106b, 106c, etc.) with which a user can interact to view, set up, modify, or otherwise manage a gift idea 103 and its presentation within the user interface 100. As shown in the example of FIG. 1, the user interface 100 can include a user interface element 106a to create a new occasion. This feature can be used to enter a new occasion, such as an event or type of occasion, a date, a new contact associated with the occasion, a relationship held between the new contact and the user, as well as various other information. The system can generate a new gift idea 103 for the new occasion to be presented within the user interface 100.

According to various examples, interactions with the various elements appearing in the user interface 100 can result in the approval and purchase of a gift associated with the gift idea 103, the addition, subtraction, or modification of a gift idea 103, or other changes to the user interface 100. For example, a user could select a gift idea 103 and be presented with the option to purchase a gift associated with the gift idea 103 as well as options for modification of the gift idea 103, generation of a message to accompany the gift, or other options. In some examples, the user interface 100 can be automatically updated with new gift ideas 103 based on upcoming occasions on a calendar associated with a user account.

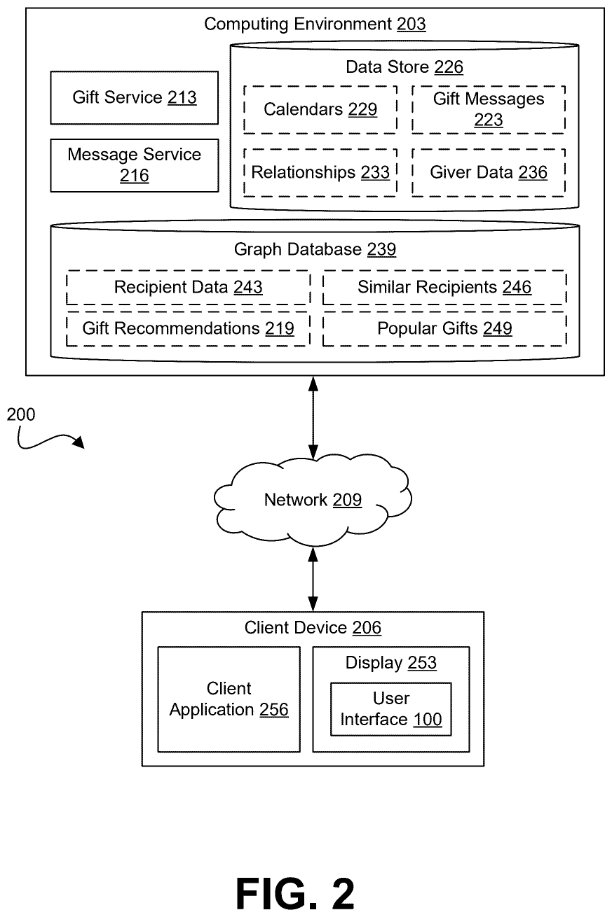

With reference to FIG. 2, shown is a network environment 200 according to various embodiments. The network environment 200 can include a computing environment 203 and a client device 206, which can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource, or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a gift service 213, a message service 216, and other applications, services, processes, systems, engines, or functionality not discussed in detail herein.

The gift service 213 can be executed to generate gift recommendations 219. The gift service 213 can collect various data in order to produce a gift recommendation 219. For example, the gift service 213 can identify data about the giver, the recipient, the type of occasion, and potentially data about a population having similar demographics to the recipient. In some examples, the gift service 213 can obtain the recipient data from the giver by first generating a request for recipient data, sending the request to a client device 206 associated with a giver, and receiving from the user an input corresponding to the recipient data in response. Then, the gift service 213 can use the data to determine a gift recommendation 219 corresponding to the recipient. Using machine learning, the gift service 213 can analyze the data about the giver, recipient, occasion, and population to develop one or more personalized gift recommendations 219. In some embodiments, the gift service 213 can send a number of gift recommendations 219 to a giver to allow the giver to select the preferred gift recommendation 219. The gift service 213 can do so by sending one or more gift recommendations 219 to a client device associated with a giver and receiving a selection of a gift recommendation 219 from the one or more gift recommendations 219. The gift service 213 can provide the selected gift recommendation 219 to a message service 216 for generation of a gift message 223. In some examples, the gift service 213 can also initiate a delivery of a gift associated with the selected gift recommendation 219.

The message service 216 can be executed to generate a gift message 223 corresponding to the gift recommendation 219. In some embodiments, the message service 216 can generate the gift message 223 based at least in part on the selection of the gift recommendation 219 received by the gift service 213. The message service 216 can generate a gift message 223 using a generative machine learning model. In some examples, the message service 216 can generate the gift message 223 based at least in part on language data associated with the giver.

Also, various data can be stored in a data store 226 that is accessible to the computing environment 203. The data store 226 can be representative of a plurality of data stores 226, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 226 is associated with the operation of the various applications or functional entities described below. This data can include gift messages 223, calendars 229, relationships 233, giver data 236, and potentially other data.

Individual gift messages 223 can represent a message generated by the message service 216 which is associated with a gift recommendation 219. A gift message 223 can be specific to a gift recommendation 219 and, in some examples, are generated based at least in part on giver data 236. A gift message 223 is sent to a recipient on behalf of a giver. In some examples, the gift messages 223 can represent a text message, a voice message, a video message, or other message.

The calendars 229 can represent a collection of days, holidays, occasions, events, or other series of seasonal information. In some examples, a calendar 229 is associated with the user account of a giver. A calendar 229 can include information about various occasions which the giver has provided, as well as general gift-giving holiday information (e.g., Valentine's Day, Mother's Day, Father's Day, Christmas, Purim, Hanukkah, Diwali, etc.). In some examples, a calendar 229 includes information about occasions such as the date of the occasion, the type of the occasion, a recipient associated with the occasion, or other information.

Relationships 233 can represent the various ways in which a giver and a recipient are connected. For example, a relationship 233 can represent a spousal, familial, household, romantic, social, or professional relationship between a giver and a recipient. In some examples, the relationships 233 can represent information about a relationship between the giver and each contact associated with the giver's user account.

Giver data 236 can be representative of a variety of data associated with the giver and the giver's user account. The giver data 236 can include demographic data about the giver such as age, gender, race, ethnicity, residence, profession, income, and various other demographic data about the giver. In some examples, the giver data 236 can also include the gift-giving history of the giver, a contact list from which relationships 233 can be derived, as well as message and language data (e.g., voice data, speaking patterns, writing samples, video data, etc.).

Additionally, various data can be stored in a graph database 239 that is accessible to the computing environment 203. The graph database 239 can be hosted by one or more data storage applications or data structures. Moreover, combinations of these databases, data storage applications, and/or data structures can be used together to provide a single, logical, graph database 239. The data stored in the graph database 239 can be stored in the form of nodes (e.g., entities) and edges (e.g., relationships between the nodes). The data stored in the computing environment graph database 239 is associated with the operation of the various applications or functional entities described herein. This data can include gift recommendations 219, recipient data 243, similar recipients 246, popular gifts 249, and potentially other data.

Gift recommendations 219 can be representative of a best match recommendation of an item for purchase, a gift card or certificate, an experience, a booking or reservation, a donation, or other potential gift which can be given to a recipient. The gift recommendations 219 can be stored in the graph database 239 as nodes related to various activities or recipients.

Recipient data 243 can be representative of a variety of data associated with a recipient, and in some instances, a user account associated with the recipient. The recipient data 243 can include demographic data about the recipient such as age, gender, race, ethnicity, residence, profession, income, and various other demographic data about the recipient. The recipient data 243 can include transaction history, purchase history, spending habits, engagement history with various activities or events, as well as other behavioral data about the recipient. In some examples, the recipient data 243 can also include the gift-receiving history of the recipient, a relationship with the giver, as well as potentially other data.

Similar recipients 246 can represent recipients of gifts from other givers who are similar to the present recipient. In some examples, the similar recipients 246 are demographically similar, similar through spend and transaction history, and/or similar in type of relationship with their respective givers. In some examples, the similar recipients 246 are similar in other manners. The graph database 239 can include recipient data 243 about each of the similar recipients 246.

Popular gifts 249 can be representative of items for purchase, gift cards or certificates, experiences, bookings or reservations, donations, or other gifts which are commonly given to similar recipients 246. Popular gifts 249 can be associated with various types of similar recipients 246. In some examples, popular gifts 249 can be used to determine a best match gift recommendation 219.

The client device 206 is representative of a plurality of client devices that can be coupled to the network 209 The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 206 can include one or more displays 253, such as liquid crystal displays (LCDs), gas plasma-based flat panel displays, organic light emitting diode (OLED) displays, electrophoretic ink (“E-ink”) displays, projectors, or other types of display devices. In some instances, the display 253 can be a component of the client device 206 or can be connected to the client device 206 through a wired or wireless connection.

The client device 206 can be configured to execute various applications such as a client application 256 or other applications. The client application 256 can be executed in a client device 206 to access network content served up by the computing environment 203 or other servers, thereby rendering a user interface 100 on the display 253. To this end, the client application 256 can include a browser, a dedicated application, or other executable, and the user interface 100 can include a network page, an application screen, or other user mechanism for obtaining user input. The client application 256 can be executed to receive the user inputs from the user interface 100. The client device 206 can be configured to execute applications beyond the client application 256 such as email applications, social networking applications, word processors, spreadsheets, or other applications.

Next, a general description of the operation of the various components of the network environment 200 is provided. To begin, a giver can request via a user interface 100 to give a gift to a recipient. The gift service 213 can receive the request to give a gift and proceed to obtain recipient data 243 associated with the recipient. However, in some examples, the gift service 213 can automatically begin the process by identifying an occasion in a calendar 229. The gift service 213 can identify a date, an occasion type, and a recipient associated with the occasion. Then, the gift service 213 can obtain the recipient data 243. In some examples, the gift service 213 can determine a gift recommendation 219 based at least in part on a query of a graph database 239, using the recipient data 243 as a key. Then, the message service 216 can generate a gift message 223 corresponding to the gift recommendation 219 determined by the gift service 213. In some examples, the message service 216 can use a generative machine learning model to generate the gift message 223. The message service 216 can generate the gift message based at least in part on giver data 236, such as language data associated with the giver. The gift service 213 can send the gift recommendation 219 to a client device 206 associated with the giver. Similarly, the message service 216 can send the gift message 223 to the client device 206 associated with the giver. In some examples, the client application 256 can cause the gift message 223 and the gift recommendation 219 to be presented to the giver through the user interface 100. The giver can approve both the gift message 223 and the gift recommendation 219 through an input to the user interface 100. The client application 256 can receive this approval input and send an approval notification to the gift service 213 and the message service 216 respectively. Then, the gift service 213 can initiate a delivery of a gift corresponding to the gift recommendation 219 to the recipient. Similarly, the message service 216 can send the gift message to a client device 206 associated with the recipient. In some embodiments, the gift service 213 and the message service 216 can automatically send the gift and the gift message 223 to the recipient without the steps to receive giver approval.

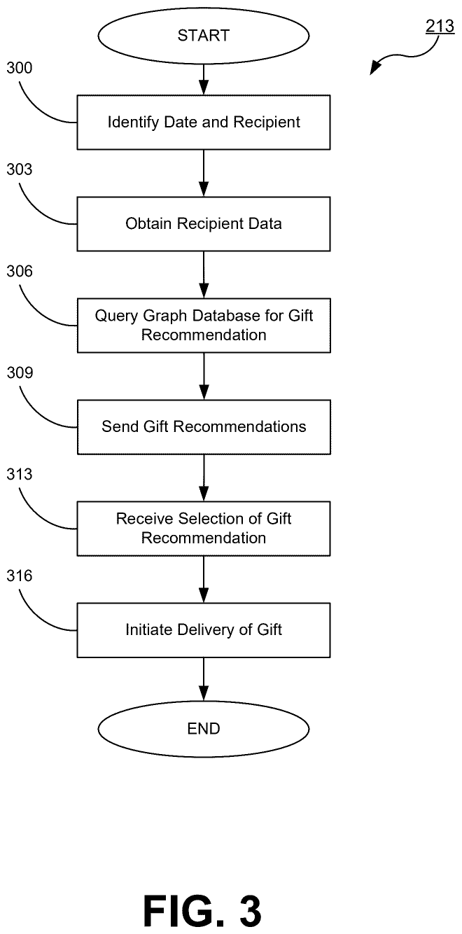

Referring next to FIG. 3, shown is a flowchart that provides one example of the operation of a portion of the gift service 213 The flowchart of FIG. 3 provides merely an example of the many different types of functional arrangements that can be employed to implement the operation of the depicted portion of the gift service 213 As an alternative, the flowchart of FIG. 3 can be viewed as depicting an example of elements of a method implemented within the network environment 200.

Beginning with block 300, the gift service 213 can be executed to identify a date and a recipient. The gift service 213 can be triggered by the entry of an occasion on a calendar 229, and in response to detecting this entry, identify a date and a recipient associated with the occasion. According to various examples, the gift service 213 can identify the date based at least in part on a calendar 229 associated with the giver. The gift service 213 can identify the recipient based at least in part on a relationship 233 identified between the recipient and the giver. For example, the gift service 213 an identify February 14th as a potential date for a gift based at least in part on the inclusion of the holiday Valentine's Day on a calendar 229 associated with the giver. The gift service 213 can then identify the recipient to be Contact A based at least in part on a spousal relationship 233 identified between the giver and Contact A. Accordingly, the gift service 213 can use an occasion on a calendar 229 to identify both a date and a recipient. In some examples, the gift service 213 receives a request for a gift and identifies a date and recipient based at least in part on the request. The gift service 213 can identify a date and a recipient from a data store 226 or from another system or service in the network environment 200. In some examples, the gift service 213 can identify other data as well, such as a type of occasion, the giver, or other data.

Next, at block 303, the gift service 213 can be executed to obtain recipient data 243. The gift service 213 can obtain recipient data 243 associated with the recipient identified at block 300. In some examples, the gift service 213 can obtain recipient data 243 from a data store 226, a graph database 239, or another system or service in the network environment 200. In some examples, the gift service 213 can obtain recipient data 243 by generating a request for recipient data 243 and sending the request to a client device associated with the giver. The gift service 213 can then receive an input which corresponds to the requested recipient data 243.

Then, at block 306, the gift service 213 can be executed to query a graph database 239 for a gift recommendation 219. The gift service 213 can use the recipient data 243 obtained at block 303 as a key to query a graph database 239 for a gift recommendation 219. By using the edges between nodes, the gift service 213 can use recipient data 243, similar recipients 246, and popular gifts 249 as well as potentially other data to determine a gift recommendation 219. In some examples, the gift service 213 can determine a gift recommendation 219 from the graph database 239 based at least in part on the query using the recipient data 243. For example, the gift service 213 can identify one or more similar recipients 246 based at least in part on the query of the graph database 239. Next, the gift service 213 can determine one or more popular gifts 249 associated with the one or more similar recipients 246. Then, the gift service 213 can determine a gift recommendation 219 based at least in part on the one or more popular gifts 249. In some examples, the gift service 213 can determine one or more gift recommendations 219 based at least in part on the query of the graph database 239.

At block 309, the gift service 213 can be executed to send a gift recommendation 219. The gift service 213 can send the gift recommendation 219, or one or more gift recommendations 219, determined at block 306 to a client device 206 associated with the giver. In some examples, the gift service 213 sends the gift recommendation 219 to the client application 256 of the client device 206. In some examples, the gift service 213 sends the gift recommendation 219 to the message service 216, a data store 226, or another system or service in the network environment 200.

At block 313, the gift service 213 can be executed to receive a selection of a gift recommendation 219. In some examples, the gift service 213 receives a selection or an approval of a gift recommendation 219 in response to sending the gift recommendation 219 at block 309. In some examples, when the gift service 213 sends multiple gift recommendations 219, the gift service 213 can receive a selection of a preferred gift recommendation 219 from the multiple gift recommendations 219. In some examples, when the gift service 213 sends one gift recommendation 219, the gift service 213 can receive an approval or rejection of the gift recommendation 219. The gift service 213 can receive the selection of a gift recommendation 219 from a client application 256 on the client device 206 associated with the giver, or from another application, device, system, or service within the network environment 200.

Next, at block 316, the gift service 213 can be executed to initiate a delivery of a gift. In some examples, the gift service 213 initiates a delivery of a gift associated with the gift recommendation 219. The gift service 213 can automatically initiate the delivery of the gift associated with the gift recommendation 219 in response to identify the gift recommendation 219 from the graph database 239 at block 306. In some examples, the gift service 213 initiates the delivery of the gift associated with the gift recommendation 219 in response to receiving the selection of the gift recommendation 219 at block 313. The gift service 213 can use recipient data 243 obtained at block 303 to determine a physical address, an email address, a client device 206, an account, or other destination for the gift, and initiate delivery of the gift to the destination. For example, if the gift recommendation 219 is for a physical item, the gift service 213 can place an order for the item to be delivered to the recipient's address. In another example, if the gift recommendation 219 is for electronic tickets to an event or experience, the gift service 213 can initiate a purchase of the tickets to be delivered to an account or email address associated with the recipient. After block 316, the flowchart of FIG. 3 comes to an end.

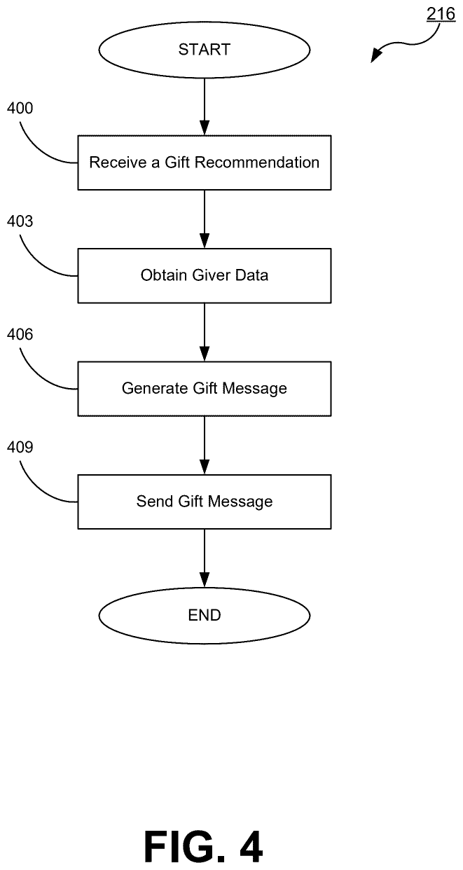

Referring next to FIG. 4, shown is a flowchart that provides one example of the operation of a portion of the message service 216 The flowchart of FIG. 4 provides merely an example of the many different types of functional arrangements that can be employed to implement the operation of the depicted portion of the message service 216. As an alternative, the flowchart of FIG. 4 can be viewed as depicting an example of elements of a method implemented within the network environment 200.

Beginning with block 400, the message service 216 can be executed to receive a gift recommendation 219. The message service 216 can receive a gift recommendation 219 from the gift service 213. In some examples, the message service 216 can receive a selection of a gift recommendation 219 from a client application 256 on a client device 206 associated with the giver. In some examples, the message service 216 can obtain the gift recommendation 219 from a data store 226, or another system or service in the network environment 200.

Next, at block 403, the message service 216 can be executed to obtain giver data 236. In some examples, the message service 216 obtains giver data 236 in response to receiving the gift recommendation 219 at block 400. The giver data 236 can include language data, writing samples, voice samples, video samples, previous messages between the giver and the recipient, and potentially other information. The message service 216 can obtain giver data 236 based at least in part on the gift recommendation 219 received at block 400. In some examples, the message service 216 obtains the giver data from a data store 226 or another system or service in the network environment 200.

Then, at block 406, the message service 216 can be executed to generate a gift message 223. The message service 216 can use a generative machine learning model to generate a gift message 223 which corresponds to the gift recommendation 219 received at block 400. In some examples, the message service 216 can generate the gift message 223 based at least in part on the giver data 236 obtained at block 403. For example, the message service 216 can train generative artificial intelligence with the giver data 236 obtained at block 403 to generate a gift message 223 in the tone and style of the giver. In some examples, the message service 216 can obtain gift messages 223 associated with popular gifts 249 and use a machine learning model generate a gift message 223 corresponding to the gift recommendation 219 received at block 400. In some examples, the message service 216 can use a combination of giver data 236 and gift messages 223 associated with popular gifts 249 as well as other data to generate a gift message 223 corresponding to the gift recommendation 219.

At block 409, the message service 216 can be executed to send the gift message 223. In some examples, the message service 216 can send the gift message 223 generate at block 406 to a client device 206 associated with the giver. In some examples, the message service 216 can send the gift message 223 to a client device 206 associated with the recipient. The message service 216 can send the gift message 223 in response to generating the gift message 223 at block 406 or in response to receipt of a prompt or approval. In some examples, the message service 216 sends the gift message 223 to a data store 226 or other system or service in the network environment 200. After block 409, the flowchart of FIG. 4 comes to an end.

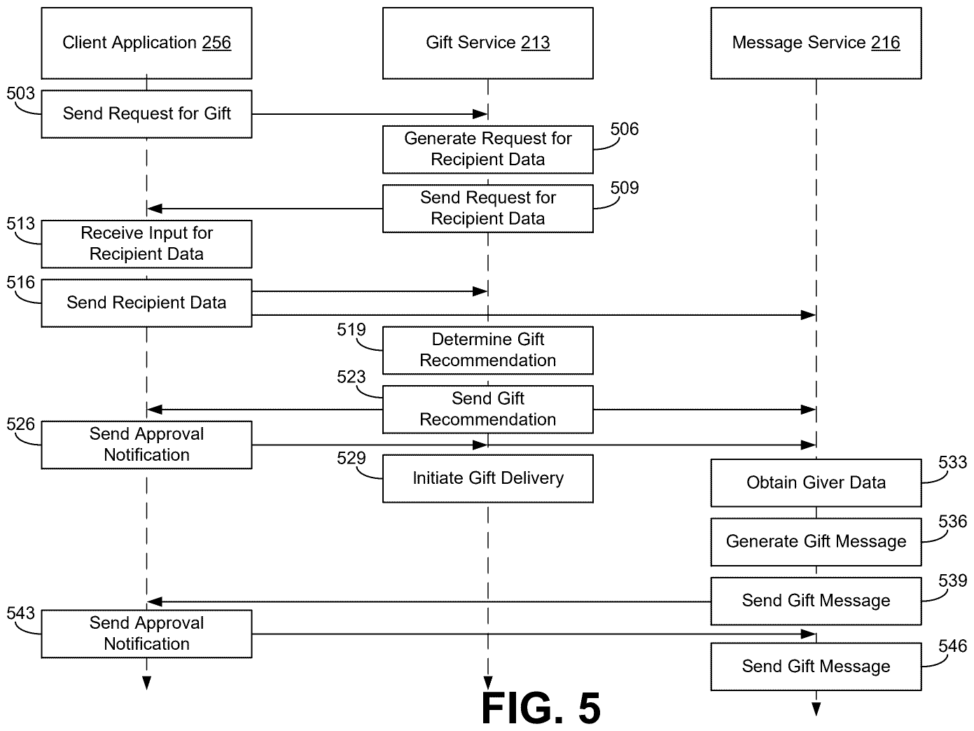

Moving on to FIG. 5, shown is a sequence diagram illustrating one example of the interactions between a client application 256, the gift service 213, and the message service 216 according to various embodiments. It is understood that the sequence diagram of FIG. 5 provides merely an example of the many different types of functional arrangements that can be employed to implement the operation of the interactions between the client application 256, the gift service 213, and the message service 216. As an alternative, the sequence diagram of FIG. 5 can be viewed as depicting an example of elements of a method implemented within the network environment 200 (FIG. 2) according to one or more embodiments.

Beginning with block 503, the client application 256 can be executed to send a request for a gift. In some examples, the client application 256 can be executed to receive a user input. In some examples, the client application 256 can receive the user input through a user interface 100 of the client device 206. The user input can be representative of a request to initiate the gift service 213. In some examples, the client application 256 generates the request for a gift based at least in part on a received user input. For example, the client application 256 can convert the received user input into a request for a gift. Then, the client application 256 can send the request for a gift to the gift service 213.

Moving to block 506, the gift service 213 can be executed to generate a request for recipient data 243. In some examples, the gift service 213 can generate a request for recipient data 243 in response to receiving the request for a gift from block 503. The gift service 213 can receive the request for a gift, identify a recipient associated with the request for a gift, and generate a request for recipient data 243 based at least in part on the identified recipient. In some examples, the gift service 213 can generate the request for recipient data 243 if the gift service 213 fails to identify a recipient associated with the request for a gift.

Next, at block 509, the gift service 213 can be executed to send a request for recipient data 243. In some examples, the gift service 213 can send the request for recipient data 243 generated at block 506 to the client application 256. In some examples, the gift service 213 can send the request for recipient data 243 to another system or service in the network environment 200.

At block 513, the client application 256 can be executed to receive input corresponding to recipient data 243. The client application 256 can receive the request for recipient data 243 sent from the gift service 213 at block 509. The client application 256 can present a request for recipient data 243 on the user interface 100 of a client device 206 associated with the giver in response to receiving the request for recipient data 243 from the gift service 213 at block 509. In some examples, the client application 256 can receive input from the user interface 100 which corresponds to the request for recipient data 243. The input can represent the recipient data 243 which was requested.

At block 516, the client application 256 can be executed to send recipient data 243. The client application 256 can use the input received at block 513 to determine recipient data 243. The client application 256 can send the recipient data 243 associated with the input received at block 513 to the gift service 213 and/or to the message service 216. In some examples, the client application 256 can send the recipient data 243 to another system or service in the network environment 200.

Then, at block 519, the gift service 213 can be executed to determine a gift recommendation 219. The gift service 213 can determine a gift recommendation 219 based at least in part on the recipient data 243 received from the client application 256 at block 516. In some embodiments, the gift service 213 can determine a gift recommendation 219 as described in the discussion of block 306 of FIG. 3. The gift service 213 can determine one or more gift recommendations 219 to share with the message service 216.

At block 523, the gift service 213 can be executed to send a gift recommendation 219. In some examples, the gift service 213 can send the gift recommendation 219 determined at block 519 to the client application 256 on a client device 206 associated with the giver. The gift service 213 can send one or more gift recommendations 219 to the client application 256 for approval or for selection of a preferred gift recommendation 219. In some examples, the gift service 213 sends the gift recommendations 219 determined at block 519 to the message service 216 or to another system, service, or application in the network environment 200.

At block 526, the client application 256 can be executed to send an approval notification. In some examples, the client application 256 can receive the gift recommendation 219 sent from the gift service 213 at block 523 and present the gift recommendation 219 to the user through the user interface 100. The client application 256 can receive an input corresponding to an approval or a rejection for the gift recommendation 219. The client application 256 can convert the input to an approval notification indicating an approval or rejection of the gift recommendation 219. Then, the client device 206 can send the approval notification to the gift service 213.

At block 529, the gift service 213 can be executed to initiate a gift delivery. The gift service 213 can determine a gift associated with the gift recommendation 219 determined at block 519 based at least in part on the approval notification received from the client application 256 at block 526. In some examples, the gift service 213 initiates the gift delivery based at least in part on recipient data 243 received from the client application 256 at block 516. As described in the discussion of block 316 of FIG. 3, the gift service 213 can use recipient data 243 to determine a physical address, an email address, a client device 206, an account, or other destination for the gift, and initiate delivery of the gift to the destination.

Moving to block 533, the message service 216 can be executed to obtain giver data 236. The message service 216 can be executed to obtain giver data 236 from a data store 226 in the network environment 200. In some embodiments, the message service 216 can obtain giver data 236 in response to receiving a gift recommendation 219 (as shown in block 523) or in response to receiving a request to generate a gift message 223.

At block 536, the message service 216 can be executed to generate a gift message 223. As described in the discussion of block 406 of FIG. 4, the message service 216 can use a generative machine learning model to generate a gift message 223 which corresponds to the gift recommendation 219 received from the gift service at block 523. In some examples, the message service 216 can generate the gift message 223 based at least in part on the giver data 236 associated with the gift recommendation 219. For example, the message service 216 can train generative artificial intelligence with the giver data 236 obtained at block 533 and associated with the gift recommendation 219 to generate a gift message 223 in the tone and style of the giver. In some examples, the message service 216 can obtain gift messages 223 associated with popular gifts 249 and use a machine learning model generate a gift message 223 corresponding to the gift recommendation 219 received at block 400. In some examples, the message service 216 can use a combination of giver data 236 and gift messages 223 associated with popular gifts 249 as well as other data to generate a gift message 223 corresponding to the gift recommendation 219.

Next, at block 539, the message service 216 can be executed to send the gift message 223. In some examples, the message service 216 can send the gift message 223 to the client application 256 of a client device 206 associated with the giver for approval. The message service 216 can send the gift message 223 generated at block 536 to the client application 256 based at least in part on a giver associated with the gift recommendation 219 received from the gift service 213.

At block 543, the client application 256 can be executed to send an approval notification. In some examples, the client application 256 can receive the gift message 223 sent from the message service 216 at block 539 and present the gift message 223 to the user through the user interface 100. The client application 256 can receive an input corresponding to an approval or a rejection for the gift message 223. The client application 256 can convert the input to an approval notification indicating an approval or rejection of the gift message 223. Then, the client device 206 can send the approval notification to the message service 216.

At block 546, the message service 216 can be executed to send the gift message 223. In some examples, the message service 216 can receive the approval notification sent from the client application 256 at block 543 and send the gift message 223 in response to receiving the approval notification. In some examples, the message service 216 can send the gift message 223 to a recipient associated with the gift recommendation 219 received from the gift service 213. After block 546, the sequence diagram of FIG. 5 comes to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a plurality of computing devices, each of the plurality of computing devices comprising a processor and a memory;
a first set of machine-readable instructions stored in a respective memory of at least one of the plurality of computing devices that, when executed by a respective processor of the at least one of the plurality of computing devices, causes the at least one of the plurality of computing devices to:
identify a date and a recipient associated with the date;
obtain recipient data associated with the recipient; and
using the recipient data as a key, query a graph database for a gift recommendation corresponding to the recipient; and
a second set of machine-readable instructions stored in a respective memory of at least one of the plurality of computing devices that, when executed by a respective processor of at least one of the plurality of computing devices, causes at least one of the plurality of computing devices to:
generate, using a generative machine learning model, a gift message corresponding to the gift recommendation; and
send the gift message to the recipient.

2. The system of claim 1, wherein the first set of machine-readable instructions further cause at least one of the plurality of computing devices to at least:
send one or more gift recommendations to a client device associated with a giver;
receive a selection of a gift recommendation from the one or more gift recommendations; and
wherein the second set of machine-readable instructions further cause at least one of the plurality of computing devices to at least generate the gift message based at least in part on the selection of the gift recommendation.

3. The system of claim 1, wherein the first set of machine-readable instructions further cause at least one of the plurality of computing devices to at least initiate delivery of a gift associated with the gift recommendation to the recipient.

4. The system of claim 1, wherein the first set of machine-readable instructions which cause at least one of the plurality of computing devices to identify the date and the recipient further cause at least one of the plurality of computing devices to at least:
identify the date based at least in part on a calendar associated with a giver; and
identify the recipient based at least in part on a relationship identified between the recipient and the giver.

5. The system of claim 4, wherein the second set of machine-readable instructions further cause at least one of the plurality of computing devices to at least generate the gift message based at least in part on language data associated with the giver.

6. The system of claim 1, wherein the first set of machine-readable instructions which cause at least one of the plurality of computing devices to obtain the recipient data further cause at least one of the plurality of computing devices to at least:
generate a request for recipient data;
send the request to a client device associated with a giver; and
receive an input corresponding to the recipient data.

7. The system of claim 1, wherein the gift message comprises at least one of a text message, a voice message, or a video message.

8. A method, comprising:
identifying a date and a recipient associated with the date;
obtaining recipient data associated with the recipient;
using the recipient data as a key, querying a graph database for a gift recommendation corresponding to the recipient;
generating with a generative machine learning model, a gift message corresponding to the gift recommendation; and
sending the gift message to the recipient.

9. The method of claim 8, further comprising:
sending one or more gift recommendations to a client device associated with a giver;
receiving a selection of a gift recommendation from the one or more gift recommendations; and
generating, by the generative machine learning model, the gift message based at least in part on the selection of the gift recommendation.

10. The method of claim 8, further comprising initiating delivery of a gift associated with the gift recommendation to the recipient.

11. The method of claim 8, wherein identifying the date and the recipient further comprises:
identifying the date based at least in part on a calendar associated with a giver; and
identifying the recipient based at least in part on a relationship identified between the recipient and the giver.

12. The method of claim 11, wherein generating the gift message further comprises generating, by the generative machine learning model, the gift message based at least in part on language data associated with the giver.

13. The method of claim 8, further comprising:
generating a request for recipient data;
sending the request to a client device associated with a giver; and
receiving an input corresponding to the recipient data.

14. The method of claim 8, wherein the gift message comprises at least one of a text message, a voice message, or a video message.

15. A system, comprising:
a computing device comprising a processor and a memory;
a first set of machine-readable instructions stored in the memory that, when executed by the processor, cause the computing device to at least:
receive a request to give a gift to a recipient, the request identifying the recipient;
obtain recipient data associated with the recipient;
determine a gift recommendation based at least in part on a query of a graph database using the recipient data;
send a gift associated with the gift recommendation to the recipient; and
a second set of machine-readable instructions stored in the memory that, when executed by the processor, cause the computing device to at least:
generate a gift message using a generative machine learning model, the gift message corresponding to the gift recommendation; and
send the gift message to the recipient.

16. The system of claim 15, wherein the request to give the gift is associated with a giver.

17. The system of claim 16, wherein the second set of machine-readable instructions, when executed by the processor, further cause the computing device to at least generate the gift message based at least in part on language data associated with the giver.

18. The system of claim 16, wherein the first set of machine-readable instructions which, when executed by the processor, cause the computing device to send the gift, further cause the computing device to at least:
send the gift recommendation to a client device associated with the giver;
receive a first approval input from the client device;
send the gift to the recipient; and
wherein the second set of machine-readable instructions which, when executed by the processor, cause the computing device to send the gift message, further cause the computing device to at least:
send the gift message to the client device associated with the giver;
receive a second approval input from the client device; and
send the gift message to the recipient.

19. The system of claim 15, wherein the first set of machine-readable instructions which, when executed by the processor, cause the computing device to determine the gift recommendation, further cause the computing device to at least:
identify one or more similar recipients based at least in part on the query of the graph database;
determine one or more popular gifts associated with the one or more similar recipients; and
determine a gift recommendation based at least in part on the one or more popular gifts.

20. The system of claim 19, wherein the second set of machine-readable instructions, when executed by the processor, further cause the computing device to at least generate the gift message based at least in part on similar gift messages corresponding to the one or more popular gifts.
